(19) United States
(12) Patent Application Publication
(10) Pub. No.: US 2009/0262793 A1
(43) Pub. Date: Oct. 22, 2009

(54) Noise performance by grouping users according to signal strength or modulation and coding scheme (MCS)

(75) Inventors: Thomas Hohne, Helsinki (FI); Petri Jolma, Nurmijarvi (FI); Lauri Kuru, Espoo (FI); Antti Sevon, Vantaa (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 12/081,587

(22) Filed: Apr. 17, 2008

(51) Int. Cl. H04B 17/00

(52) U.S. Cl. 375/227

(57) ABSTRACT

Insight and rules are needed for how to handle scheduling in a way meaningful for network operation is explained, such as what transmissions can be delayed for scheduling and which cannot be delayed for scheduling, and how grouped transmissions can be used for interference avoidance. Certain embodiments of the present invention provide a solution to these and other problems. In certain embodiments of the present invention, for example, users are grouped according to criteria which may be indirectly related to interference but are nevertheless different from interference. Thus, for example, certain embodiments of the present invention use expected receive or transmit signal strength or use MCS as grouping criteria.

### CROSS REFERENCE TO RELATED APPLICATIONS

None.

### BACKGROUND OF THE INVENTION

1. Field of the Invention

The present invention generally relates to communication technologies. More specifically, the present invention relates, for example, to wireless communication. For example, certain embodiments of the present invention relate to situations where, at a receiver, signals from different transmitters are received parallel in time, or signals for different receivers are transmitted parallel in time. For instance, Long Term Evolution (LTE) of Third Generation (3G) Partnership Project (3GPP) as well as Worldwide Interoperability for Microwave Access (WIMAX) systems are designed to operate in that way. In certain embodiments, noise performance is improved by grouping users according to signal strength or Modulation and Coding Scheme (MCS).

2. Description of the Related Art

In a system like Orthogonal Frequency-Division Multiple Access (OFDMA), where different users may transmit at the same time (albeit on different frequencies), the problem may arise that some users will transmit with very high power, introducing noise levels in neighboring frequencies used by other users, and thereby degrading the received signals of the other users.

Typically these impacts in UpLink (UL) are caused by one or more of the following: power amplifier wideband noise (usually not relevant); intermodulation spectrum (can be relevant); inter-carrier-interference in OFDMA (due to imperfect orthogonality between different users' signals); loss in receiver dynamics (this can be a result of the previous points and can be taken into account in the receiver design); and oscillator phase noise.

A similar problem exists in the DownLink (DL), when a Base Station (BS) transmitter is asked to transmit high power signals simultaneously with low power signals on separate frequencies. In that case high requirements on the dynamic range and linearity of the transmitter are demanded. Typically impacts in DL are caused by one or more of the following: power amplifier wideband noise (usually not relevant); intermodulation spectrum (can be relevant); loss in receiver dynamics (this can be a result of the previous points and can be taken into account in the receiver design); and oscillator phase noise.

A system like Global System for Mobile communications (GSM) aims at controlling maximal user power by power control. In order to guarantee that Error Vector Magnitude (EVM) does not jeopardize the functioning of the system, a special safety margin of 18 dB is typically build into the system parameters. The disadvantage of this approach is that performance degradation still takes place, compared to a situation where signals have about equal strength.

The effect of removing transmission errors in a scenario with two Mobile Stations (MSs) that are first transmitting at different powers, then with adjusted strengths (it is not clear what the actual settings after the adjustment were) has been shown in an OFDMA system. It has been suggested to solve the problem with power control, namely by adjusting for problems caused by the attenuation in a first transmitter by attenuating a second transmitter. The disadvantage of this approach is that it may not be desirable to decrease the signal of one user only because another weaker user is nearby. Also, equalizing users' power is not a typical input parameter for a Power Control (PC) algorithm (except for target-received-level-based power control algorithns, but in these cases the neighbor's power is not used as input) and can increase the complexity of the system design greatly.

Another attempted solution to the problem of signal degradation due to interference suggests a scheduling solution. The approach suggests measuring user interference and ordering the users, apparently based on the measurements.

It is not clear whether those who have proposed such solutions fully appreciate the mechanisms of EVM interference. Thus, a solution to these and other problems is needed.

### SUMMARY OF THE INVENTION

One embodiment of the present invention is a method. The method includes preparing a transmission schedule. The preparing includes grouping transmissions according to at least one of transmission power or modulation and coding scheme

Another embodiment of the present invention is an apparatus. The apparatus comprises a processor configured to prepare a transmission schedule. The processor is configured to group transmissions according to at least one of transmission power or modulation and coding scheme

Further embodiments of the present invention is an apparatus. The apparatus includes processing means for preparing a transmission schedule. The preparing means includes grouping means for grouping transmissions according to at least one of transmission power or modulation and coding scheme

Yet another embodiment of the present invention is a computer-readable medium encoded with instructions that, when executed on a computer, perform a process. The process includes preparing a transmission schedule. The preparing includes grouping transmissions according to at least one of transmission power or modulation and coding scheme

### BRIEF DESCRIPTION OF THE DRAWINGS

For proper understanding of the invention, reference should be made to the accompanying drawings, wherein:

FIG. 1 is illustrates with a simple example, an embodiment of the present invention for the case of grouping according to signal strength;

FIG. 3 illustrates another method according to an embodiment of the present invention;

FIG. 4 illustrates a system according to an embodiment of the present invention; and

FIG. 5 illustrates an embodiment of the present invention as computer instructions encoded on a computer-readable medium, for execution by a computer.

### DETAILED DESCRIPTION OF THE PREFERRED EMBODIMENT(S)

Certain embodiments of the present invention relate to situations where, at a receiver, signals from different transmitters are received parallel in time, or signals for different receivers are transmitted parallel in time. For instance, Long Term Evolution (LTE) of Third Generation (3G) Partnership Project (3GPP) as well as Worldwide Interoperability for Microwave Access (WIMAX) systems are designed to operate in that way. Thus, for example, certain embodiments of the present invention relate to group transmission in the UpLink (UL) according to the expected reception power at the Base Station (BS).

Certain embodiments of the present invention propose a method for inter-carrier-interference minimization. In this method, transmissions from different MS are grouped in a way that in UL at the receiver their receive powers appear within a range A, where A can be determined as specified below. Likewise, in the method, transmissions to different Mobile Stations (MSs) are grouped in a way that in DownLink (DL) at the transmitter their transmit powers appear within a range B, where B can be determined as will be discussed at greater length below.

In particular optional embodiments of the invention, MSs are grouped according to used MCS, making use of a likely connection between higher transmit power and lower MCS, and higher transmit powers and higher distortion.

It may be possible to implement embodiments of the present invention together with scheduling according to frequency selective channels.

Certain embodiments of the present inventions may have various advantages. For example, certain embodiments of the present invention can avoid the need to increase transmission power for interfered channels.

As discussed above, in a system like Orthogonal Frequency-Division Multiple Access (OFDMA), where different users may transmit at the same time (albeit on different frequencies), the problem may arise that some users will transmit with very high power, introducing noise levels in neighboring frequencies used by other users, and thereby degrading the received signals of the other users. The various causes of these impacts in the UL are discussed above. As also discussed above, a similar problem exists in the DL, when a Base Station (BS) transmitter is asked to transmit high power signals simultaneously with low power signals on separate frequencies.

Certain embodiments of the present invention provide a solution to these and other problems. In certain embodiments of the present invention, users are grouped according to criteria which may be indirectly related to interference but are nevertheless different from interference. Thus, for example, certain embodiments of the present invention use expected receive or transmit signal strength or use MCS as grouping criteria.

The present application also provides, for example, the insight and rules how to handle the scheduling in a way meaningful for network operation: it is explained what transmissions can be delayed for scheduling and which cannot be delayed for scheduling, and how grouped transmissions can be used for interference avoidance.

Transmissions from different MSs can be grouped in a way that in the UL, at the receiver, their receive powers appear within a range A, where A can be determined as specified below. Likewise transmissions to different MSs can be grouped in a way that in the DL, at the transmitter, their transmit powers appear within a range B, where B can be determined as specified below.

In a variant of the invention, MSs can be grouped according to a used MCS, making use of a likely connection between higher transmit power and lower MCS, and higher transmit power and higher distortion.

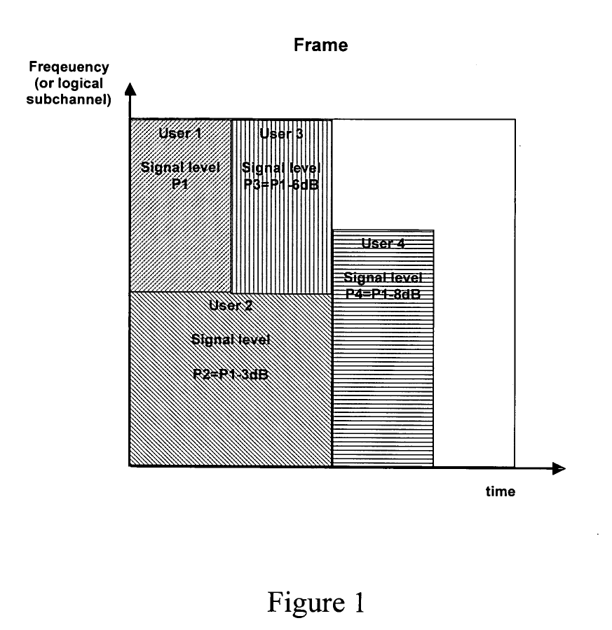

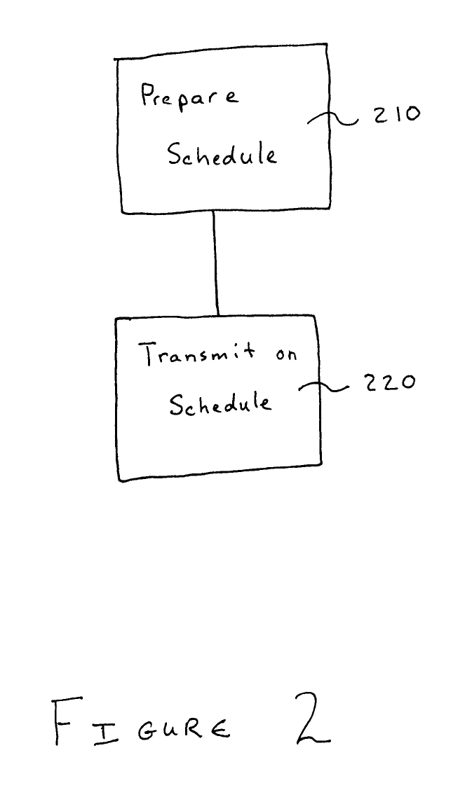

The simple example of FIG. 1 illustrates the basic idea of the invention for the case of grouping according to signal powers.

A very simple implementation concerns only L1 scheduler (signal allocation to physical frame) while more advanced solutions can include L2 scheduler considerations also.

An example of the generic approach is illustrated in FIG. 1: four users have been allocated to a frame so that signal levels are considered in the allocation. The maximum difference between signal levels at any given moment in time is 3 dB (first between users 1 & 2 and then between users 2 & 3). The 6 dB difference between users 1 & 3 is not relevant since these signals are not overlapping in time.

A less advantageous situation would occur if user 4 would be active at the same time with user 1 (max difference would be 8 dB) or user 2 (max difference would be 5 dB). User 4 could alternatively (than to the way depicted) by scheduled prior to users 1 & 2. This, however, may make implementation in the RF circuitry less favorable.

From RF-circuitry point of view optimum behavior could be monotonic transmit (receive) power change, i.e. gradually stepping the power level up or down may be better than hopping up and down in bigger random-looking steps. Furthermore, in WiMAX the DL frame preamble can be transmitted at a high power level, so at least for a WiMAX DL the high-to-low-direction in power levels may be more natural choice.

A second approach can take into account L2 parameters and neighboring cells. Depending on the latency requirements, transmissions can be grouped within a frame for time critical Packet Data Units (PDUs), or grouped in separate frames for best-effort services.

In another implementation the scheduling takes into account information from neighboring cells, so as to help interference avoidance. For instance, a frame that is scheduled for low-power transmissions in the UL may be used for low-power transmissions also in a neighboring cell, if the cells have agreed on the timing.

The “acceptable range of powers” can be a function of the Third Order Intermodulation (IM3) and other Error Vector Magnitude (EVM) noise in transmitters and receivers. There are different ways of calculating the acceptable range of powers: adaptive with feedback, adaptive with parameters, and fixed, for example.

In the adaptive with feedback way, thresholds are adapted according to feedback from the signal decoding unit. In the adaptive with parameters way, thresholds are dynamically set according to number of users present in a band, and their powers, and according to their transceiver quality if that information is available. For instance, a wider range of different transmission powers may be acceptable for a BS transmitter, compared to different transmission from a low-grade MS. Also other information such as Quality of Service (QoS) requirements that would impose restriction on the scheduler, may be taken into account. For instance, requirement of low latencies can be translated into wider ranges, as scheduling becomes easier. In the fixed way of calculating the acceptable range of powers, a precalculated fixed value can used for DL, and a different precalculated fixed value can be used for UL.

Yet another alternative, which may be especially helpful in the UL, is to group MS transmissions according to their MCS. This allows for simple implementation, and is based on the principle that MS that are required to transmit with lower MCS are more likely to be also required to transmit with higher power. While their receive power may still be similar to a MS close to the BS, high power transmission means that EVM noise also has a higher share of the signal.

Receive (Rx) power and MCS grouping can be combined such that first transmissions are grouped according to MCS and then within each MCS group according to expected reception power (or vice versa). For every MCS group the reception power range grouping parameter may be different. For instance, for 64 Quadrature Amplitude Modulation (64 QAM) the range may be smaller than for Quadrature Phase Shift Keying (QPSK).

Further, it should be pointed out that grouping transmissions is not limited to frame boundaries as it is depicted in the example. That is, transmissions may be grouped across frames by delaying transmissions within their possible expiry times

Among the advantages of various embodiments of the present invention, one advantage is that requirements on power control can be relaxed. From a different viewpoint, certain embodiments of the present invention allow a lowering of the EVM requirements compared leading to either cheaper hardware (HW) or larger coverage as low-received-power users can be decoded more reliably.

FIG. 2 illustrates a method according to an embodiment of the present invention. As shown in FIG. 2, the method can include preparing 210 a transmission schedule, in which transmissions are grouped according to at least one of transmission power or modulation and coding scheme. The preparing 210 can include grouping 215 transmission according to at least one of transmission power or modulation and coding scheme. The method can also include transmitting 220 according to the schedule.

In the method of FIG. 2, the transmission can be grouped such that transmissions that are simultaneous to one another are within an acceptable power range. This acceptable power range can be, for example, about 3 dB or about 5 dB. The schedule in method of FIG. 2 can be a schedule of at least one of an uplink schedule or a downlink schedule. A grouping for the uplink schedule can be based on different criteria from a grouping for the downlink schedule.

The transmissions can be grouped such that the difference in transmit power levels between transmission that are simultaneous is minimized. The prepared schedule can be transmitted to a remote terminal.

The transmissions can be grouped such that the difference between power levels received simultaneously from different remote terminals is minimized. The remote terminal or terminals can transmit according to the schedule.

The schedule can extend over a plurality of frames. The method can additionally include finalizing and transmitting to a remote terminal only a portion of the schedule, for a next necessary frame.

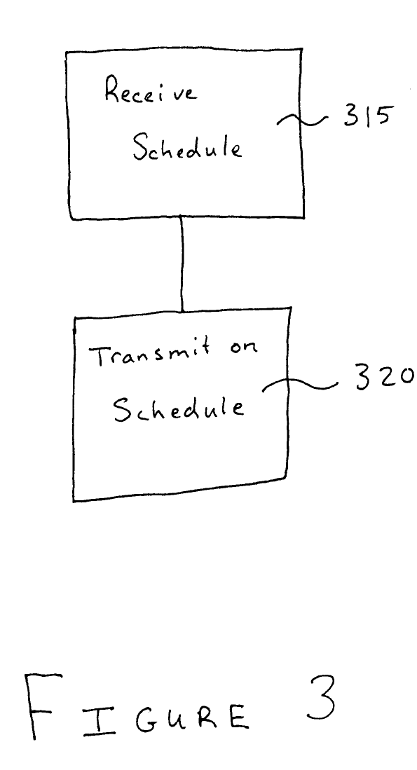

FIG. 3 illustrates another method according to an embodiment of the present invention. As shown in FIG. 3, the method can include receiving 315 a transmission schedule, in which transmissions are grouped according to at least one of transmission power or modulation and coding scheme. The method can also include transmitting 320 according to the schedule.

In the method of FIG. 3, the transmission can be grouped such that transmissions that are simultaneous to one another are within an acceptable power range. The acceptable power range can be, for example, about 3 dB or about 5 dB. The schedule in the method of FIG. 3 can be a schedule of at least one of an uplink or a downlink. A grouping for the uplink schedule can be based on different criteria from a grouping for the downlink schedule.

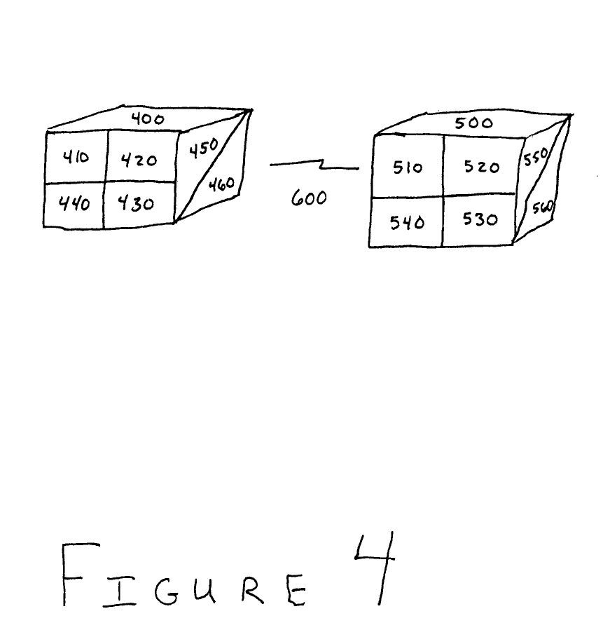

FIG. 4 illustrates a system according to an embodiment of the present invention. As shown in FIG. 4, a first apparatus 400 can include a processor 410, a transmitter 420, a receiver 430, and a memory 440. The first apparatus 400 can be a radio network device such as a Radio Network Controller (RNC) or an evolved Node B (eNodeB). In general, the first apparatus 400 may be implemented as a general purpose computer, a single chip, and/or an Application Specific Integrated Circuit (ASIC).

The processor 410 can be configured to prepare a transmission schedule, in which transmissions are grouped according to at least one of transmission power or modulation and coding scheme. The transmitter 420 can be configured to transmit according to the transmission schedule. The transmissions can be grouped such that transmissions that are simultaneous to one another are within an acceptable power range. The acceptable power range can be about 3 dB or about 5 dB. The schedule can be a schedule of at least one of an uplink or a downlink. A grouping for the uplink schedule can be based on different criteria from a grouping for the downlink schedule.

FIG. 4 also illustrates a second apparatus 500 connected to the first apparatus 400 by a communication link 600, which is illustrated as a direct wireless communication link, although there is no requirement that the communication link 600 necessarily be either wireless or direct.

As shown in FIG. 4, the second apparatus 500 can include a processor 510, a transmitter 520, a receiver 530, and a memory 540. The first apparatus 500 can be a terminal device such as a User Equipment (UE) or Mobile Station (MS). In general, the second apparatus 500 may be implemented as a general purpose computer, a single chip, and/or an Application Specific Integrated Circuit (ASIC). In certain embodiments the second apparatus 500 may be a personal digital assistant, personal computer, handheld communication device, or cellular telephone.

The processor 510 can be configured to group the transmissions such that the difference in transmit power levels between transmission that are simultaneous is minimized. The processor 510 can also or alternatively be configured to group the transmissions such that the difference between power levels received simultaneously from different remote terminals is minimized. The transmitter 520 can be configured to transmit the prepared schedule to a remote terminal.

The schedule can extend over a plurality of frames, and the processor 510 can be configured to finalize, and the transmitter 520 can be configured to transmit to a remote terminal, only a portion of the schedule for a next necessary frame.

The processor 510 or the receiver 530 can be configured to receive a transmission schedule, in which transmissions are grouped according to at least one of transmission power or modulation and coding scheme. Furthermore, the processor 510 or transmitter 520 can be configured to transmit according to the received transmission schedule. The transmissions can be grouped such that transmissions that are simultaneous to one another are within an acceptable power range. The acceptable power range can be about 3 dB. The schedule can be a schedule of at least one of an uplink or a downlink. A grouping for the uplink schedule can be based on different criteria from a grouping for the downlink schedule.

The apparatus in FIG. 4 could be, for example, a Radio Network Controller (RNC) or an eNodeB, in 3G. In WiMAX, the apparatus could be a Base Station (BS) or a separate scheduling element. Thus, the apparatus can be referred to a scheduling apparatus, which can be a standalone device or can be integrated into some other network element

The system shown in FIG. 4 can be implemented various ways. For example, the first apparatus 400 can prepare a transmission schedule and provide it to the second apparatus 500, which can then transmit according to the schedule. Alternatively, or in addition, the first apparatus 400 and the second apparatus 500 can both prepare a transmission schedule and itself transmit according to the schedule. In another embodiment, a further network entity (not shown) between the first apparatus 400 and second apparatus 500 can be instructed to provide the schedule to the second apparatus 500, and to communicate with the second apparatus 500 according to a schedule prepared by the first apparatus.

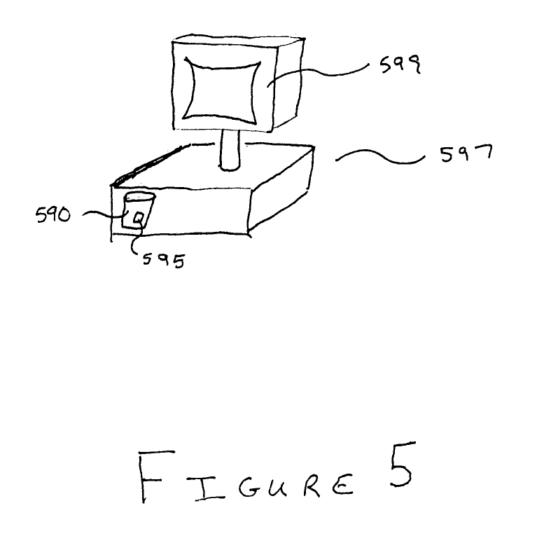

FIG. 5 illustrates an embodiment of the present invention as computer instructions encoded on a computer-readable medium, for execution by a computer. FIG. 5 illustrates a computer-readable medium 590 encoding instructions 595 that, when executed on a computer 597, perform a process, such as one of the processes shown in FIGS. 2 and 3. The computer-readable medium 590 can be any conventional computer-readable medium such as, for example, a Compact Disk (CD), Hard Drive (HD), Flash Random Access Memory (RAM), or Electronically Programmable Read Only Memory (EPROM). The computer 597 can be any conventional computing device, such as a Personal Computer (PC) or a smart (processor-carrying) telephone. Monitor 599 is shown, although there is no requirement that the computer 597 have a monitor.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
preparing a transmission schedule,
wherein the preparing comprises grouping transmissions according to at least one of transmission power or modulation and coding scheme.

2. The method of claim 1, further comprising:
transmitting according to the schedule.

3. The method of claim 1, wherein the transmissions are grouped such that the difference in transmit power levels between transmission that are simultaneous is minimized.

4. The method of claim 1, wherein the schedule is a downlink schedule.

5. The method of claim 1, further comprising:
transmitting the prepared schedule to a remote terminal.

6. The method of claim 1, wherein the transmissions are grouped such that the difference between power levels received simultaneously from different remote terminals is minimized.

7. The method of claim 1, wherein the remote terminal transmits according to the schedule.

8. The method of claim 1, wherein the schedule is an uplink schedule.

9. The method of claim 1, wherein the schedule extends over a plurality of frames.

10. The method of claim 9, further comprising:
finalizing and transmitting to a remote terminal only a portion of the schedule, for a next necessary frame.

11. An apparatus, comprising:
a processor configured to prepare a transmission schedule,
wherein the processor is configured to group transmissions according to at least one of transmission power or modulation and coding scheme.

12. The apparatus of claim 11, further comprising:
a transmitter configured to transmit according to the schedule.

13. The apparatus of claim 11, wherein the processor is configured to group the transmissions such that the difference in transmit power levels between transmission that are simultaneous is minimized.

14. The apparatus of claim 11, wherein the schedule is a downlink schedule.

15. The apparatus of claim 11, further comprising:
a transmitter configured to transmit the prepared schedule to a remote terminal.

16. The apparatus of claim 11, wherein the transmissions are grouped such that the difference between power levels received simultaneously from different remote terminals is minimized.

17. The apparatus of claim 11, wherein the schedule is an uplink schedule.

18. The apparatus of claim 11, wherein the schedule extends over a plurality of frames.

19. The apparatus of claim 18, further comprising:
a transmitter,
wherein the processor is configured to finalize, and the transmitter is configured to transmit to a remote terminal, only a portion of the schedule for a next necessary frame.

20. An apparatus, comprising:
processing means for preparing a transmission schedule,
wherein the preparing means comprises grouping means for grouping transmissions according to at least one of transmission power or modulation and coding scheme.

21. A computer-readable medium encoded with instructions that, when executed on a computer, perform a process, the process comprising:
preparing a transmission schedule,
wherein the preparing comprises grouping transmissions according to at least one of transmission power or modulation and coding scheme.
